(19) United States
(12) Patent Application Publication
(10) Pub. No.: US 2008/0116346 A1
(43) Pub. Date: May 22, 2008

(54) Adjustable multi-purpose work apparatus

(76) Inventor: Angela McCarthy, Quincy, MA (US)

Correspondence Address: ERIC HANSCOM, 7395 PORTAGE WAY, CARLSBAD, CA, 92011, US

(21) Appl. No.: 11/601,735

(22) Filed: Nov. 20, 2006

(51) Int. Cl. F16M 13/00

(52) U.S. Cl. 248/424

(57) ABSTRACT

A multi-purpose work apparatus is provided having a base portion with at least two rollers attached thereto, an adjustable support member coupled to the base portion, a tray coupled to the adjustable support, the tray comprising a plate with a curved perimeter portion defining a storage region, and an electrical outlet coupled to the adjustable support, the electrical outlet having a water-resistant electrical cord attached thereto for providing power to the electrical outlet, wherein a user can store tools, supplies, and other objects within the storage region, can plug power tools into the electrical outlet box, and can adjust the adjustable support to position the tray at a convenient work height. The apparatus can include at least one accessory holder attached to the tray, such as a cup holder, a hammer holder, a paint brush holder, and a hook. The outlet can be a ground fault interrupter circuit outlet.

### BACKGROUND OF THE INVENTION

1. Field of the Invention

The embodiments of the invention relate to the field of work stations. More specifically, the embodiments of the present invention relate to a multi-purpose work apparatus.

2. Description of the Related Art

Many individuals engage in professions that require a work surface that can contain various tools and devices. For example, plumbers, electricians, contractors, mechanics, and artists, all must have a table, easel, work bench, or other device that they can use to store items necessary to complete particular tasks. While benches and work surfaces have been designed to suit particular needs of certain professionals, such as mechanics and carpenters, many of these work surfaces are not suitable for use by other professionals, such as electricians, due to the lack of appropriate tool holding capabilities or devices that are versatile enough to have a multitude of uses.

Further, many work devices are one-dimensional in height. While this may suit some professionals, other professionals who perform work at varying heights will have to move up and down a ladder to reach the appropriate tools. This not only increases the time needed to complete a task, but also can be a great inconvenience to a professional or other person trying to complete a task. In a similar light, many work devices are not easily transportable from one location to another, further causing inconvenience to a user. Additionally, many work devices are configured such that they do not offer the ability to quickly disassemble the device for storage purposes. Further, many work devices are constructed of heavy materials that can be burdensome for users to transport without risking injury.

Therefore, there is a need for a multi-purpose work apparatus that can be configured to suit the tool holding and storage needs of various professionals, that can be height-adjustable to allow for convenient access of items by the user, that is lightweight and can be readily moved from one location to another, and that can be easily disassembled to allow for storing in areas with limited space.

In this respect, before explaining at least one embodiment of the invention in detail it is to be understood that the embodiments of the invention are not limited in their application to the details of construction and to the arrangement of the components set forth in the following description or illustrated in the drawings. The embodiments of the invention are capable of being practiced and carried out in various ways. In addition, it is to be understood that the phraseology and terminology employed herein are for the purpose of description and should not be regarded as limiting.

### SUMMARY OF THE EMBODIMENTS OF THE INVENTION

The preferred embodiment of the invention involves a multi-purpose work apparatus having a base portion with at least two rollers attached thereto, an adjustable support member coupled to the base portion, a tray coupled to the adjustable support, the tray comprising a plate with a curved perimeter portion defining a storage region, and an electrical outlet coupled to the adjustable support, the electrical outlet having a water-resistant electrical cord attached thereto for providing power to the electrical outlet. A user can store tools, supplies, and other objects within the storage region, can plug power tools into the electrical outlet box, and can adjust the adjustable support to position the tray at a convenient work height. The apparatus can include at least one accessory holder attached to the tray, such as a cup holder, a hammer holder, a paint brush holder, and a hook. The electrical outlet can be a ground fault interrupter circuit outlet.

The base portion preferably includes five support members each having a roller attached thereto. The adjustable support member can comprise a first tubular member and a second tubular member slidably positioned within the first tubular member, the second tubular member having a plurality of evenly spaced orifices therein wherethrough a locking pin or conventional spring-loaded detent can be positioned to adjust the height of the adjustable support member. The second tubular member is also preferably configured to be partially positioned within the adjustable support attachment member. A cord can be connected on one end to the adjustable support attachment member, with the locking pin connected to the other end of the cord, wherein the cord can secure the locking pin to the apparatus when the locking pin is not positioned within an orifice. The tray can further comprise a tray support attached on one end to the bottom surface of the tray, wherein the adjustable support attachment member is connected to the other end of the tray support.

The apparatus can further include at least one accessory holder removably or securely attached to the tray. Preferably, the apparatus contains a plurality of accessory holders, the accessory holders including a cup holder, a paint brush holder, a hammer holder, various sized hooks, a camera tripod, a paint tray locking device, and a paint holder.

There has thus been outlined, rather broadly, features of the embodiments of the invention in order that the detailed description thereof may be better understood, and in order that the present contribution to the art may be better appreciated. There are additional features of the embodiments of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principals of the embodiments of the invention.

FIG. 1 is a side perspective view of the preferred embodiment of the multi-purpose work apparatus.

FIG. 2 is a top view of the base portion of the preferred embodiment of the multi-purpose work apparatus, detached from the rest of the apparatus.

FIG. 3 is a bottom view of the base portion of the preferred embodiment of the multi-purpose work apparatus, detached from the rest of the apparatus.

FIG. 4 is partially broken away detailed side view of the base portion and the lower adjustable support of the preferred embodiment of the multi-purpose work apparatus.

FIG. 5 is a top view of the base portion of another embodiment of the multi-purpose work apparatus, detached from the rest of the apparatus.

FIG. 6 is a bottom view of the tray portion of the preferred embodiment of the multi-purpose work apparatus, detached from the rest of the apparatus.

FIG. 7 is a top view of the tray portion of another embodiment of the multi-purpose work apparatus, detached from the rest of the apparatus.

FIG. 8 is a detailed side view of the tray portion and upper adjustable support of the preferred embodiment of the multi-purpose work apparatus.

FIG. 9 is a front perspective view of a cup holder device for attachment to the tray portion of the preferred embodiment of the multi-purpose work apparatus.

FIG. 10 is a front perspective view of a paintbrush holder device for attachment to the tray portion of the preferred embodiment of the multi-purpose work apparatus.

FIG. 11 is a side view of a hammer holder device for attachment to the tray portion of the preferred embodiment of the multi-purpose work apparatus.

FIG. 12 is a side view of a paint liner device for removable attachment to the tray portion of the preferred embodiment of the multi-purpose work apparatus.

### DETAILED DESCRIPTION OF THE EMBODIMENTS

Referring now to the drawings, wherein similar parts are identified by like reference numerals, FIG. 1A and FIG. 1B are side perspective views of the preferred embodiment of the multi-purpose work apparatus 10. Apparatus 10 includes a base portion 20, an adjustable support member 30, a tray portion 40, and an electrical outlet 60. Apparatus 10 is designed to assist home owners, painters, electricians, plumbers, mechanics, artists, or other professionals who need a work surface that can be adjusted to various heights. Apparatus 10 can be comprised of heavy duty durable plastic material or lightweight metal, such as aluminum.

Base portion 20 preferably includes five support members 22 (three shown) each having a roller 24 attached thereto. However, base portion 20 can include less than five support members 22, such as two or three, or more than five support members 22, such as six or seven, depending on the design of base portion 20. Rollers 24 are preferably 2″ castors that allow apparatus 10 to be rolled from one work position to another. Base portion 20 includes a support opening 25 for receiving adjustable support member 30. Opening 25 is preferably centrally located within base portion 20 and is preferably 1.5″ in diameter. Base portion 20 also includes a round weight (see FIG. 3) to help stabilize apparatus 10. Weight 29 is preferably a 3.375″ diameter round lead weight, but can comprise other shapes and can be comprised of different metallic material.

Adjustable support member 30 can comprise a first tubular member 32 and a second tubular member 34 slidably positioned within first tubular member 32. First tubular member 32 is preferably 2″ in outside diameter and is 38.5″ in height. One end 35 of first tubular member 32 is connected to base portion 20. The other end 38 of first tubular member 32 receives second tubular member 34. Second tubular member 34 can contain a plurality of evenly spaced orifices 36 therein, on one or more sides, through which a conventional spring-loaded detent 33 can be positioned to adjust the height of adjustable support member 30. Orifices 36 are preferably ⅜″ in diameter and are located every 3″ along second tubular member 34. Orifices 36 are preferably drilled on opposing surfaces of second tubular member 34 to allow positioning of an external locking pin 74 there through. Second tubular member 34 is also preferably configured to be partially positioned within an adjustable support attachment member 48 attached to tray portion 40. As another adjustment means, a cord 72 can be connected on one end to adjustable support attachment member 48, with external locking pin 74 connected to the other end of cord 72, wherein cord 72 can secure locking pin 74 to apparatus 10 when locking pin 74 is not positioned within an orifice 36. Cord 72 can be secured to a ring 71 connected to one of securing screws 70. End 38 includes two ½″ ¾ round circles cut into the top portion thereof to allow for detent 33 or locking pin 74 to be positioned to securely lock second tubular member 34 in place.

Tray portion 40 comprises a plate 42 with curved side portions 44 defining a storage region 45. A user can store tools, supplies, and other objects within storage region 45. Tray portion 40 can further comprise a tray support 46 attached on one end to the bottom surface of plate 42, wherein adjustable support attachment member 48 is connected to the other end of tray support 46. Adjustable support attachment member 48 is preferably connected to a tray support tubular member (not shown) that is welded to tray support 46. Tray support tubular member is preferably centrally secured to tray support 46 and is 1.5″ long and has an outside diameter of 1.75″. Attachment member 48 is configured to be slidably positioned over tray support tubular member and removably secured thereto by securing screws 70, such that a user can remove tray portion 40 from adjustable support member 30 to facilitate shipping and storage of apparatus 10.

Outlet 60 provides the ability for a user to plug power tools or other power devices into box 62, without having to use multiple extension cords. Box 62 can be a ½″ electrical box that can be welded onto either attachment member 48 (as shown in FIG. 1B) or first tubular member 32 (as shown in FIG. 1A). Box 62 preferably contains two sockets 66. Box 62 can also include a 20 amp ground fault interrupter circuit (GFCI) switch 68. GFCI switch 68 can help to prevent serious injury by tripping and quickly stopping the flow of electricity in the event that a ground fault occurs. Electrical outlet 60 includes a cord 69 attached thereto for providing power to box 62. Cord 69 can be a P-136-49 MSH 12 AWG 3/C SJ00W 90 C 300V water resistant electrical cord. Cord 69 is preferably 20′ long, but can be any length to suit various needs. A strain relief connector can be attached to box 62 and cord 69 such that cord 69 cannot be disconnected from box 62. Box 62 can include straight blade, locking plugs and connectors wired for a 15 amp and 20 amp plug. A multi-application weather-proof receptacle cover 64 can be attached to box 62 to cover sockets 66. Apparatus 10 can include 2 cleats 92 for securing cord 69 around when cord 69 is not in use.

Apparatus 10 further includes at least one accessory holder (see FIGS. 9-12) removably or securely attached to tray portion 40. Preferably, apparatus 10 contains multiple accessory holders. The accessory holders can include, but not be limited to: a cup holder, a paint brush holder, a hammer holder, various sized hooks, a camera tripod, a paint tray locking device, and a paint liner.

FIG. 2 is a top view of base portion 20. This figure illustrates the location of support members 22, opening 25, and rollers 24. Preferably, one roller 24 is attached to each one of support members 22. As shown, base portion 20 includes five support members 22. However, base portion 20 can include more or less support members 22 to achieve different objectives.

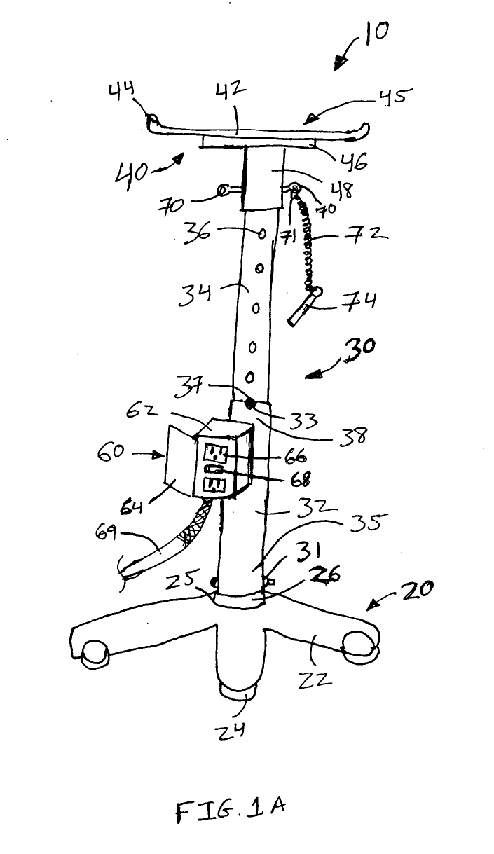

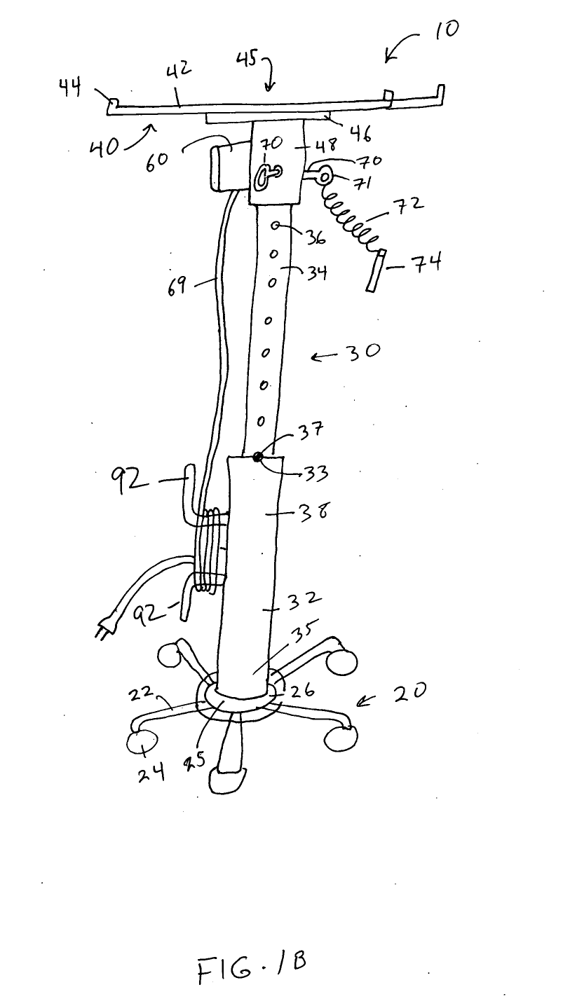

FIG. 3 is a bottom view of the base portion 20. In particular, this figure illustrates the positioning of weight 29 on base portion 20. Weight 29 preferably contains an opening (not shown) in the center wherein an eyebolt 28 can be disposed therein and connected to machine bolt 31 that runs horizontally through adjustable support 32 (see FIG. 4). Eyebolt 28 is preferably attached to weight 29 via a wing nut 27, to provide the user the ability to assemble and disassemble adjustable support 32 from base portion 20. Other nuts can also be used as securing mechanisms, as would be recognized in the art.

FIG. 4 is partially broken away detailed side view of base portion 20 and adjustable support 30, illustrating the attachment of base portion 20 to adjustable support 30. As shown, eyebolt 28 extends from base portion 20 into first tubular member 32. Machine bolt 31 passes through the eye (not shown) of eyebolt 29, providing a secure attachment for eyebolt 28 within first tubular member 32. Eyebolt 29 is secured to base portion 20 by being attached to weight 29 via a wing nut 27.

FIG. 5 is a top view of the base portion 80 of another embodiment of the multi-purpose work apparatus 10, detached from the rest of the apparatus 10. Base portion 80 includes three support members 82 and an opening 86 centrally located therein for the attachment of adjustable support member 30. In this embodiment, base portion 80 includes slip-resistant stabilizers 84 secured to each of support members 82, to prevent base portion 80 from moving from one position to another while a user is utilizing apparatus 10 on an inclined surface or smooth surface.

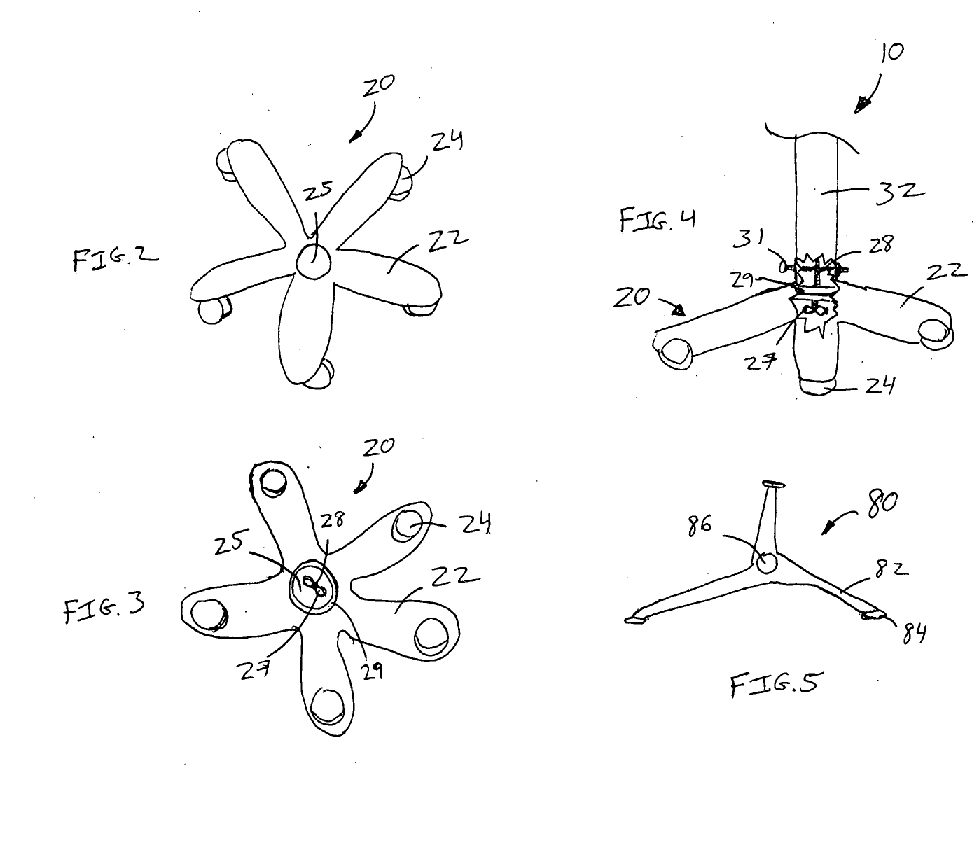

Referring now to FIGS. 6 and 7, FIG. 6 is a bottom view of plate 42 detached from the rest of apparatus 10. Plate 42 contains curved side portions 44 defining a storage region 45. A user can store tools, supplies, and other objects within storage region 45. Plate 42 can contain several holes 43 therein for attachment of tray support 46 to plate 42 via attachment bolts (not shown). FIG. 7 is a top view of plate 42 detached from the rest of apparatus 10. Plate 42 can include two protrusions 49 on one end for securing a painting roller tray (not shown) thereto.

FIG. 8 is a detailed side view of tray portion 40 and the upper region of adjustable support 30. Tray portion 40 can include a center post 90 for serving as a stabilization means for a camera or other equipment to be positioned thereon. Post 90 can include external threads 91 to secure equipment thereto. Also shown in this figure are cleats 92 that serve to secure cord 69 to apparatus 10 when cord 69 is not in use.

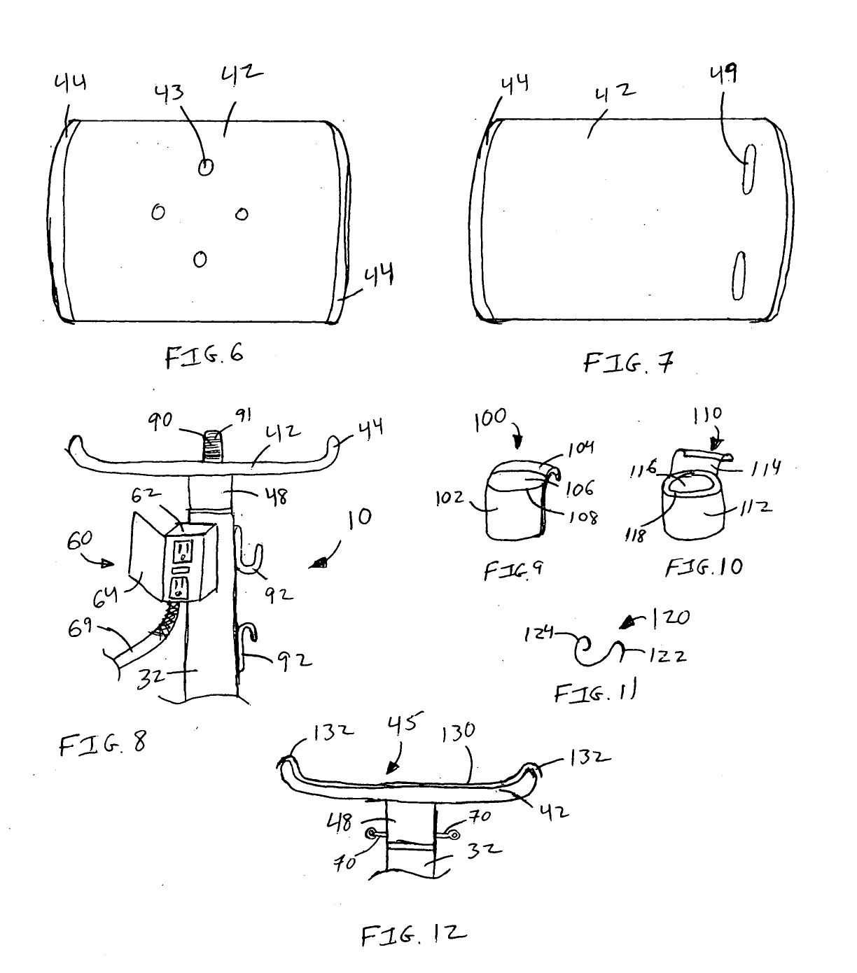

Referring now to FIGS. 9-12, these figures illustrate various attachment devices that can be secured to tray portion 40. FIG. 9 is a front perspective view of a cup holder device 100, including a body portion 102, an attachment portion 104, and an opening 106 defined by a rim 108 for receiving a cup or can. FIG. 10 is a front perspective view of a paint brush holder device 110, including a body portion 112, an attachment portion 114, and an opening 116 defined by a rim 118 for receiving a paintbrush there through. FIG. 11 is a side view of a hammer holder device 120, including an attachment end 122 designed to fit over curved side portion 44, and a hook end 124 designed to securely attach a hammer to apparatus 10. FIG. 12 is a side view of a paint liner device 130 for removable attachment to tray portion 40. Device 130 is shaped to fit within storage region 45 of tray portion 40. Device 130 can be used to store paint, other fluids, or other loose material such as sawdust. The aforementioned devices are not conclusive as to the types of devices that can be utilized with tray portion 40, as other devices can be designed to be secured to tray portion 40, such as those to contain screwdrivers, spackle trays, knives, lighting fixtures, tape, towels, art supplies, or other devices as would be recognized as useful to various professionals by one with ordinary skill in the art.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

The above description, together with the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Office and the public generally, and especially the scientists, engineers, and practitioners in the art who are not familiar with patent or legal terms or phraseology, to quickly determine the nature and essence of the technical disclosure of the application. The abstract is neither intended to define the invention of the application, which is measured by the claims, nor is it intended to be limiting, as to the scope of the invention in any way.

I claim:

1. A multi-purpose work apparatus comprising:
a) a base portion, the base portion having a top surface and a bottom surface, the base portion including at least two rollers attached to the bottom surface;
b) an adjustable support member coupled on one end to the top surface;
c) a tray coupled to the other end of the adjustable support, the tray comprising a substantially flat plate having two a tray top surface, a tray bottom surface, a curved perimeter portion defining a storage region, and an adjustable support attachment member coupled to the tray bottom surface; and
d) an electrical outlet coupled to the adjustable support, the electrical outlet having a water-resistant electrical cord attached thereto for providing power to the electrical outlet
wherein a user can store hand tools, work supplies, and other objects within the storage region, can plug electrical powered tools into the electrical outlet box, and can adjust the adjustable support to position the tray at a convenient work height.

2. The multi-purpose work apparatus of claim 1, wherein the base portion comprises at least three support members, each of the at least three support members including a top surface and a bottom surface.

3. The multi-purpose work apparatus of claim 2, wherein the base portion includes three rollers, each roller attached to the bottom surface of each of the at least three support members.

4. The multi-purpose work apparatus of claim 1, wherein the adjustable support member is screwed to the base portion.

5. The multi-purpose work apparatus of claim 1, wherein the adjustable support member comprises a first tubular member and a second tubular member slidably positioned within the first tubular member, the second tubular member having a plurality of evenly spaced orifices therein wherethrough a locking pin or conventional spring-loaded detent can be positioned to adjust the height of the adjustable support member, the second tubular member configured to be partially positioned within the adjustable support attachment member.

6. The multi-purpose work apparatus of claim 5, further comprising a cord connected on one end to the adjustable support attachment member, the locking pin connected to the other end of the cord, wherein the cord can secure the locking pin to the apparatus when the locking pin is not positioned within an orifice.

7. The multi-purpose work apparatus of claim 1, wherein the tray top surface contains at least two protrusions on one end for securing a painting roller tray thereto. ((Angela: can you think up any other painting attachements?))

8. The multi-purpose work apparatus of claim 1 further comprising a tray support attached on one end to the tray bottom surface, wherein the adjustable support attachment member is connected to the other end of the tray support.

9. The multi-purpose work apparatus of claim 1, wherein the electrical outlet comprises a ground fault circuit interrupter outlet.

10. The multi-purpose work apparatus of claim 1 further comprising at least one accessory holder for removable attachment to the tray.

11. The multi-purpose work apparatus of claim 10, wherein the at least one accessory holder is a cup holder.

12. The multi-purpose work apparatus of claim 10, wherein the at least one accessory holder is a paint brush holder.

13. The multi-purpose work apparatus of claim 10, wherein the at least one accessory holder is a hook.

14. The multi-purpose work apparatus of claim 1 further comprising a tripod support coupled to the tray top surface for the purpose of providing stabilization for camera equipment attached to the apparatus.

15. A multi-purpose work apparatus comprising:
a) a base portion, the base portion having a top surface and a bottom surface, the base portion including at least two rollers attached to the bottom surface;
b) an adjustable support member coupled on one end to the top surface, the adjustable support member comprising a first tubular member and a second tubular member slidably positioned within the first tubular member, the second tubular member having a plurality of evenly spaced orifices therein wherethrough a locking pin or conventional spring-loaded detent can be positioned to adjust the height of the adjustable support member, the second tubular member configured to be partially positioned within the adjustable support attachment member;
c) a tray coupled to the other end of the adjustable support, the tray comprising a substantially flat plate having two a tray top surface, a tray bottom surface, a curved perimeter portion defining a storage region, a tray support attached on one end to the tray bottom surface, and an adjustable support attachment member coupled to the other end of the tray support; and
d) an electrical outlet coupled to the adjustable support, the electrical outlet having a water-resistant electrical cord attached thereto for providing power to the electrical outlet, the electrical outlet comprising a ground fault circuit interrupter outlet
wherein a user can store hand tools, work supplies, and other objects within the storage region, can plug electrical powered tools into the electrical outlet box, and can adjust the adjustable support to position the tray at a convenient work height.

16. The multi-purpose work apparatus of claim 15 further comprising at least one accessory holder for removable attachment to the tray.

17. The multi-purpose work apparatus of claim 16, wherein the at least one accessory holder is selected from the group consisting of a cup holder, a paint brush holder, a hammer holder, and a hook.

18. A multi-purpose work apparatus comprising:
a) a base portion, the base portion having a top surface and a bottom surface, the base portion including at least two rollers attached to the bottom surface;
b) an adjustable support member coupled on one end to the top surface, the adjustable support member comprising a first tubular member and a second tubular member slidably positioned within the first tubular member, the second tubular member having a plurality of evenly spaced orifices therein wherethrough a locking pin or conventional spring-loaded detent can be positioned to adjust the height of the adjustable support member, the second tubular member configured to be partially positioned within the adjustable support attachment member;
c) a tray coupled to the other end of the adjustable support, the tray comprising a substantially flat plate having two a tray top surface, a tray bottom surface, a curved perimeter portion defining a storage region, a tray support attached on one end to the tray bottom surface, and an adjustable support attachment member coupled to the other end of the tray support;
d) an electrical outlet coupled to the adjustable support, the electrical outlet having a water-resistant electrical cord attached thereto for providing power to the electrical outlet, the electrical outlet comprising a ground fault circuit interrupter outlet; and
e) at least one accessory holder removably attached to the tray
wherein a user can store hand tools, work supplies, and other objects within the storage region, can plug electrical powered tools into the electrical outlet box, and can adjust the adjustable support to position the tray at a convenient work height.

19. The multi-purpose work apparatus of claim 18, wherein the at least one accessory holder is selected from the group consisting of a cup holder, a paint brush holder, a hammer holder, and a hook.

20. The multi-purpose work apparatus of claim 19 further comprising a cord connected on one end to the adjustable support attachment member, the locking pin connected to the other end of the cord, wherein the cord can secure the locking pin to the apparatus when the locking pin is not positioned within an orifice.
